(19) United States
(12) Patent Application Publication
(10) Pub. No.: US 2020/0039283 A1
(43) Pub. Date: Feb. 6, 2020

(54) Decorative Aggregate

(71) Applicant: Nordgröna AB, Arlöv (SE)

(72) Inventor: Sander Oudendijk, Höör (SE)

(73) Assignee: Nordgröna AB, Arlöv (SE)

(21) Appl. No.: 16/341,428

(22) PCT Filed: Oct. 12, 2017
(86) PCT No.: PCT/EP2017/076044

§ 371 Date: Apr. 11, 2019

(30) Foreign Application Priority Data
Oct. 13, 2016 (SE) 1651343-4

(51) Int. Cl. B44C 1/28; A01G 9/02; B44C 5/06; A47G 7/04

(52) U.S. Cl. CPC B44C 1/28; A01G 9/025; A01G 9/027; A47G 7/044; B44C 5/06

(57) ABSTRACT

The invention refers to a decorative aggregate (10) adapted to be mounted to a surface (100). The aggregate (10) comprises a plurality of elements (1). Each element comprises a container (2) having a bottom wall (3) and side walls (4) delimiting a cavity (5), a filling (9) of a vegetative material disposed in the cavity (5), and a fastener (8) adapted to mount the element (1) to the surface (100). The invention also refers to an element of a decorative aggregate.

### FIELD OF THE INVENTION

The invention relates to a decorative aggregate adapted to be mounted to a surface. The invention also relates to an element adapted to form part of a decorative aggregate.

### BACKGROUND OF THE INVENTION

It is well known in the art to provide a wall decoration made of a vegetative material such as moss. Due to the properties of the vegetative material the wall decoration will not only serve as a decoration but also absorb acoustics.

The vegetative material is preserved by using a preservation ingredient such as various salts or glycerin and color pigments and then mounted onto a two-dimensional backing such as a wooden tile or chipboard. The backing may also be provided as a flexible felt. The mounting of the vegetative material onto the backing is made by hand using e.g. adhesive. The wall decorations typically have different geometries such as rectangular, circular or quadrangular panels having a size of about 30-100 cm×30-200 cm.

The wall decoration is mounted to a surface, either like a stand-alone painting or side by side, abutting each other to thereby cover a larger surface. The wall decorations may be attached to the wall by e.g. using fasteners such as hook and loop fasteners or Velcro©.

When mounting several wall decorations side by side it is very hard or even impossible to cover a larger area without facing problems with limitations in terms of positions of windows, doors, sockets etc. Not only is there an obvious risk to damage the vegetative material if the decorations should be cut, but also a very patchy, less eye-appealing surface is likely to result. Further, should a loss or damage occur, which is not unlikely since many people are attempted to touch the vegetative material out of curiosity, it is difficult to replace one piece of decoration without damaging adjacent pieces. Further, due to the inherent properties of the vegetative material it is more or less impossible to get uniform coloring of the material. This is especially the case if a decoration should be replaced by a decoration from another batch.

Yet another problem related to the prior art panels is that the panels due to their size may be too heavy to cover an entire wall. Some walls are not constructed for such a weight. Hence, the prior art wall decorations may very much limit design possibilities, both in terms of size and weight.

There is accordingly a need to provide a simplified surface decoration made of a vegetative material which allows more freedom when providing a custom made surface decoration and which also allows replacement of damaged pieces of surface decorations or adaption to specific requirements of the surface such as sockets, windows, doors, or the like.

### SUMMARY OF THE INVENTION

It is an object of the present invention to solve at least some of the problems mentioned above. According to a first aspect a decorative aggregate adapted to be mounted to a surface is provided. The aggregate comprises a plurality of elements, each element comprising a container having a bottom wall and side walls delimiting a cavity; a filling of a vegetative material disposed in the cavity; and a fastener adapted to mount the element to the surface.

Thus, the inventive aggregate comprises a plurality of elements, each element being formed as a container containing a filling of a vegetative material. By the container shape, each element may be considered as an individual pixel. Depending on the size of each element, the visual patchiness may be eliminated or greatly reduced. Thereby a larger area may be composed by elements where the individual containers contain a filling of one and the same color but from different batches. Also decorative patterns may be composed on the users own discretion. In fact, a large surface area covered by a plurality of smaller sized elements will be experienced as being more vivid and appealing. The small size of the elements allows for the reduction of visibility of unnatural lines and shapes caused by the seams in-between different elements of the surface decoration. Further, the container shaped elements allow for individual replacement over time of damaged elements. The aggregate allows for better adaption to the physical properties of a surface area to be covered, such as positions and size of windows, doors and sockets. Also, by the aggregate, the necessity and time consuming work of custom-cutting larger panels to fit the surface area to be covered may be reduced or even eliminated.

The aggregate may be arranged on any surface, such as a wall, a ceiling or a pillar. The term surface in the context of the invention should not be limited to a solid surface but may also be arranged to a flexible surface such as a curtain or the like. The individual elements may even be arranged to be threaded as beads on a string.

The container may have an opening arranged opposite the bottom wall, and wherein the filling is inserted into the cavity via said opening.

The container may be formed by e.g. injection molding, press forming, felt molding or felt making. The container may also be formed from a flat sheet of material e.g. by folding, gluing, stapling or stitching. It is to be understood that the design of the flat sheet should be adapted to the intended forming method.

The fastener may be arranged on the bottom wall and/or on at least one side wall of the container. By arranging the fastener on at least one side wall, the user can easily adapt its intended pattern to irregular surfaces and also to cover edges where necessary.

The fastener may be a fastener of the hook-and-loop type, such as Velcro©. In case of a hook-and-loop type fastener, the material of the container as such may form the loop side. The fastener may also be a laminate comprising a hook-and-loop type layer, an adhesive layer and a removable cover strip. The fastener may also be an adhesive tape.

The filling may be a vegetative material such as moss or lichen. The filling may be preserved by using preservation ingredients such as salts or glycerin. The filling may also be provided with color pigments. The filling may be treated to be fire resistant.

The filling may be disposed in the cavity by using adhesive. Although a sufficient fixation in the container may be provided by the vegetative material itself having a slightly soft, entangling and flexible character, it may in some circumstances be favorable to also use adhesive as a safety measure.

The side walls of the container may have a height in the range of 2-6 cm and more preferred 3-5 cm. Likewise, the side walls of the container may have a width in the range of 2.5-15 cm and more preferred 3-8 cm. These small dimensions give the user a great degree of freedom to decide regarding the visual appearance of the surface area to be decorated. By arranging elements of different colors or even different types of vegetative fillings, a surface decoration of a desired pattern may be provided. Also, the small dimensions contribute to a visual elimination of natural variations in the vegetative material and coloring between different batches. Further, unnatural lines and shapes caused by the seams in-between different elements are made less visible.

A plurality of elements may be provided as an array on a sheet. Thereby the sheet can be handled as one unit to be mounted to a surface, such as a wall. This allows a substantially reduced mounting time since each sheet will cover a larger area than an individual element. The elements are preferably arranged side by side forming a quadrangular array, such as a quadratic or rectangular array. The lower surface of the sheet may be provided with fasteners. Alternatively, the sheet itself may be a fastener. The sheet may be provided by a flexible or rigid material.

According to another aspect, the invention refers to an element of a decorative aggregate comprising a container, the container having a bottom wall and side walls delimiting a cavity, wherein at least the bottom wall on its exterior side comprises a fastener, and the cavity is filled with a vegetative material.

The element as such has previously been described in the context of the aggregate and to avoid undue repetition reference is made to the previous discussion.

A further scope of applicability of the present invention will become apparent from the detailed description given below. However, it should be understood that the detailed description and examples, while indicating preferred embodiments of the invention, are given by way of illustration only, since various changes and modifications within the scope of the invention will become apparent to those skilled in the art from this detailed description.

Hence, it is to be understood that this invention is not limited to the component parts of the device described or steps of the methods described as such device and method may vary. It is also to be understood that the terminology used herein is for purpose of describing particular embodiments only, and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTION OF THE DRAWINGS

These and other aspects of the present invention will now be described in more detail, with reference to the appended drawings showing embodiments of the invention. The figures are provided to illustrate the general structures of embodiments of the present invention. Like reference numerals refer to like elements throughout.

FIG. 1 discloses one embodiment of an element forming part of the aggregate.

FIG. 2 discloses one embodiment of an aggregate comprising a plurality of elements mounted to a surface.

FIG. 3 discloses one embodiment with a sheet supporting a plurality of elements.

### DETAILED DESCRIPTION

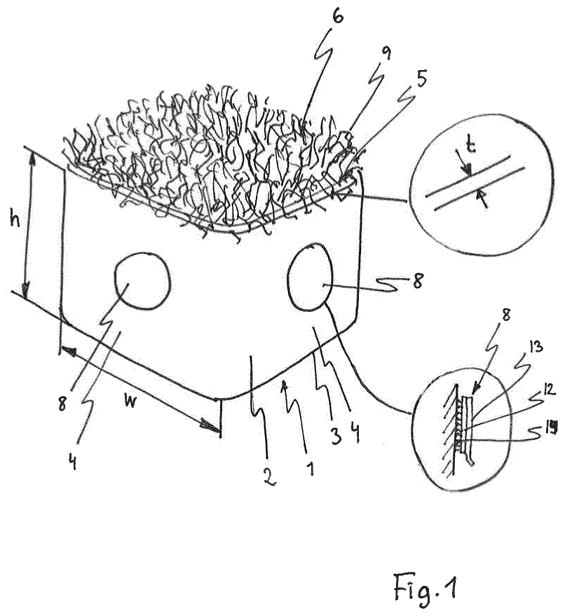

Starting with FIG. 1 the general design of a decorative element 1 forming part of the aggregate 10 is disclosed.

The element 1 comprises a container 2 having a bottom wall 3 and side walls 4 delimiting a cavity 5 having an opening 6 opposite the bottom wall 3. In the disclosed embodiment the element 1 has a square geometry. The invention should however not be restricted to this geometry. As non-limiting examples of geometries, the container 2 may be rectangular, circular, oval or hexagon. The container 2 has a height h defined by the side walls 4 in the range of 2-6 cm and more preferred 3-5 cm. Also, the container 2 has a width w defined by the side walls 4 in the range of 2.5-15 cm and more preferred 3-8 cm.

The container 2 is formed as a seamless container. This allows for an inherent stiffness. The seamless container 2 may be formed e.g. injection molding, press forming, felt molding or felt making. It is to be understood that the container 2 alternatively may be formed from a flat sheet e.g. by folding, gluing, stapling or stitching. The design of the flat sheet should be adapted to the intended forming method. This applies especially to the position of areas intended to form part of joints. The skilled person will understand that a container may be folded in a number of ways and that the design of flaps and slots and hence the flat unfolded sheet of material to form the walls may be designed in a number of ways.

The container 2 may be made of a flexible material, such as a woven textile material or felt. It is to be understood that also other types of material may be used, such as a plastic material or a combination of a plastic and textile material. The flexible material may be organic or synthetic. Examples of organic material are wool or hamp. The thickness t may, depending on the type of material be 1-15 mm. In case of a felt material, the thickness is preferably 2-7.5 mm.

The container 2 comprises fasteners 8. The fasteners 8 are arranged on the exterior of the bottom wall 3. In the disclosed embodiment, the fastener 8 is a laminate comprising a hook-and-loop type layer 14 and an adhesive layer 12. The hook-and-loop-type layer 14 faces the container 2 and the adhesive layer 12 faces away from the container 2. The adhesive layer 12 is provided with a removable cover strip 13.

The skilled person will understand that other types of fasteners are possible. By way of example, the fastener 8 may be any suitable fastener, such as a hook-and-loop type fastener of the Velcro ©-type. The fastener 8 may also be an adhesive. In case of a hook-and-loop type fastener 8, the container 2 may be provided with the loop-part on its bottom wall 3, whereas the surface, such as a wall onto which the element 1 is to be mounted is provided with the hook-type part. Thereby the risk of accidental interlocking of elements 1 and damages to the vegetative material during transport and storing is reduced. The loop-part may be formed by the material making up the container 2 in case this material has a fluffy characteristic. The latter is typically the case if the material is a textile or felt.

The often high-frictional surface properties provided by a textile or felt material will contribute to the fixation of the elements 1 abutting each other when mounted in a pixel like pattern on a surface. The locking effect between different elements 1 may be enhanced by providing fasteners 8 on at least one of two opposing side walls 4.

In case the container 2 also is provided with fasteners 8 on a side wall 4, it is preferred that these are removable arranged, e.g. by using an adhesive or a stitch. The user may then decide, depending on the intended surface pattern and surface condition, whether the fastener 8 is necessary or not. The fasteners 8 arranged on the side walls 4 may be of the hook-type to thereby allow engagement with the material making up the container 2. Alternatively, a first pair of opposing side walls 4 of an element 1 may be provided with fasteners 8 of the hook-type whereas a second pair of opposing side walls 4 may be provided with fasteners 8 of the loop-type.

A filling 9 of a vegetative material is disposed in the cavity. The vegetative material may be any organic material. The vegetative material may be any type of moss or lichen such as Reindeer moss, Reindeer Lichen or Caribou moss. The filling 9 may be preserved by using preservation ingredients such as salts or glycerin. Also, the vegetative material may be treated to be fire resistant. The vegetative material may be provided in its natural colors. Alternatively, the vegetative material may be colored by using color pigments.

The filling 9 is inserted into the cavity 5 to fill the same to such extent that the container 2 is made substantially invisible when viewing the container 2 from the top side. It is preferred that the filling 9 is made to such extent that the filling 9 extends over the side walls 4. Also, the degree of filling may be made to such extent that the side walls 4 slightly bulge. The filling 9 may be inserted into the cavity 5 either by hand or by using any automatic machinery line.

The filling 9 may be secured inside the cavity 5 based on a combination of its own inherent flexibility, the degree of filling and friction between the filling 9 and the inner walls of the container 2. As a safety measure the filling 9 may also be secured in the cavity 5 by using an adhesive. The adhesive may be applied in a number of ways, e.g. as a spraying or dip coating the ends of the vegetative material to be inserted into the cavity 5.

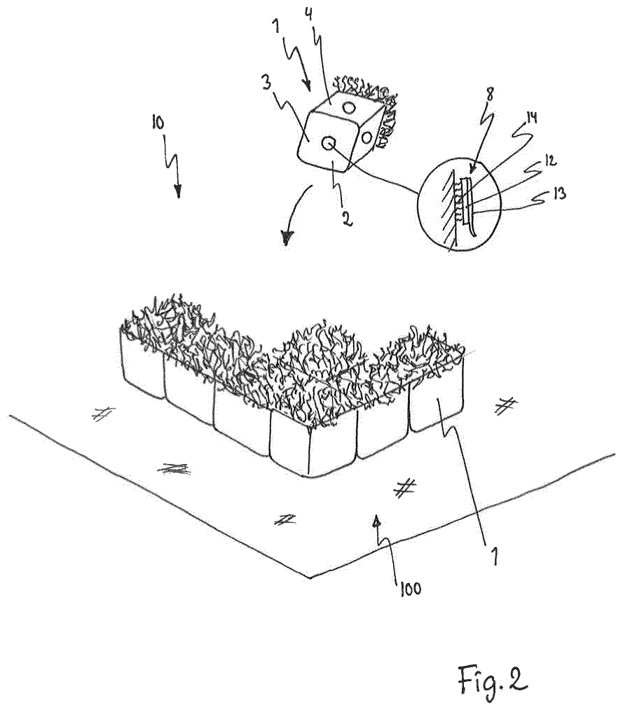

Now turning to FIG. 2 an aggregate 10 according to the invention is schematically disclosed. The walls of the individual elements 1 are provided with fasteners 8 on their bottom walls 3. Also, the individual elements 1 are provided with optional fasteners 8 on their side walls 4. The fasteners 8 have a circular shape, although it is to be understood that other geometries are possible. Also, the disclosed fasteners 8 are in the form of a laminate comprising a hook-and-loop type layer 14, an adhesive layer 12 and a removable cover strip 13.

When mounting the individual elements 1 to a surface 100, the cover strip 13 is removed and the element 1 is pressed against the surface 100. Thereby the element will adhesively engage the surface 100. In the disclosed embodiment the individual elements 1 are also provided with optional fasteners 8 on their side walls 4.

A plurality of elements are arranged side by side with the side walls 4 abutting each other, thereby forming a pixel-like pattern where each element 1 is considered as an individual pixel. It is to be understood that other patterns may be used such as a slight displacement between adjacent rows. By providing elements 1 of different colors and also, possibly with different vegetative fillings 9, the user may create his/her own visual appearance of the surface. In fact, a large surface covered by a plurality of smaller sized elements abutting each other will be experienced as being more vivid and appealing due to the natural, inherent variances of the vegetative material.

In case of damage, individual elements may easily be replaced simply by detaching the hook-and-loop engagement and/or the adhesive engagement. Further, the aggregate allows for better adaption to the physical properties of an area to be covered, such as positions and size of windows, doors and sockets.

In another, not disclosed embodiment, a surface to be decorated by the aggregate may be provided with fasteners of the hook-type. These fasteners may e.g. be provided by strips forming a net structure. Further, the individual elements may be provided with fasteners of the loop-type on their bottom walls. Alternatively, the material as such making up the container may be used as a loop-type fastener. The individual elements are mounted to the surface by pressing the bottom walls against the surface. Thereby the fastener on the bottom wall of the element will engage the mating fastener on the surface.

The aggregate may be arranged on any surface, such as a wall, a ceiling, or a pillar.

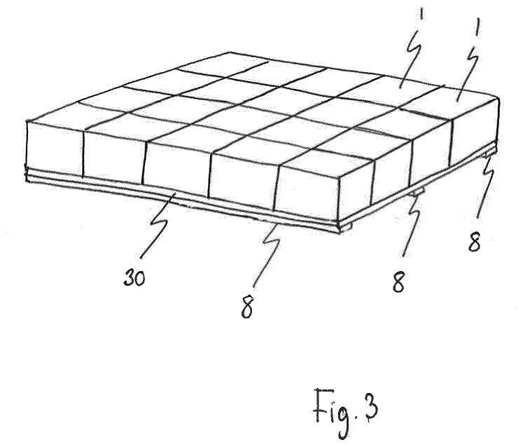

Now turning to FIG. 3, one embodiment of a sheet 30 with a plurality of elements 1 is shown. To facilitate understanding, the filling has been omitted. The sheet 30 supports a plurality of elements 1 arranged in an array, side by side. The elements 1 are preferably arranged side by side forming a quadrangular array. The array may by way of example be quadratic or rectangular. The lower surface of the sheet 30 may be provided with fasteners 8. Alternatively, the sheet 30 itself may be a fastener. It is to be understood that the fasteners 8 may be provided in any shape and in any pattern. The fasteners 8 may even be omitted and the sheet 30 be arranged to be mounted to a surface by using screws, nails, staples or even adhesive. The sheet 30 may be provided by a flexible material or by a rigid material such as a board. In case of a flexible material, this may be of the same type as the elements, such as a woven textile material or felt. It is to be understood that also other types of material may be used, such as a plastic material or a combination of a plastic and textile material. The flexible material may be organic or synthetic. Examples of organic material are wool or hamp.

A flexible material allows the sheet 30 to be mounted on a non-flat surface. No matter type of material in the sheet 30, the sheet 30 may be cut by the end-user in order to adapt its size to the surface to be decorated by the elements.

Variations to the disclosed embodiments can be understood and effected by the skilled person in practicing the claimed invention, from a study of the drawings, the disclosure, and the appended claims.

1. Decorative aggregate adapted to be mounted to a surface, the aggregate comprising a plurality of elements, each element comprising:
a container having a bottom wall and side walls delimiting a cavity, said bottom wall and side walls being made of a textile material or felt;
a filling of a preserved vegetative material disposed in the cavity; and
a fastener adapted to mount the element to the surface, wherein a plurality of elements are arranged side by side with the side walls abutting each other, thereby forming a pixel-like pattern.

2. Decorative aggregate according to claim 1, wherein the container has an opening arranged opposite the bottom wall, and wherein the filling is inserted into the cavity via said opening.

3. Decorative aggregate according to claim 1, wherein the fastener is arranged on the exterior bottom wall and/or on at least one exterior side wall of the container.

4. Decorative aggregate according to claim 1, wherein the fastener is of the hook-and-loop type, or wherein the fastener is a laminate comprising a hook-and-loop type layer, an adhesive layer and a removable cover strip.

5. Decorative aggregate according to claim 1, wherein the preserved vegetative filling is moss or lichen.

6. Decorative aggregate according to claim 1, wherein the filling is disposed in the cavity by using adhesive.

7. Decorative aggregate according to claim 1, wherein the side walls of the container have a height in the range of 2-6 cm and more preferred 3-5 cm.

8. Decorative aggregate according to claim 1, wherein the side walls of the container have a width in the range of 2.5-15 cm and more preferred 3-8 cm.

9. Decorative aggregate according to claim 1, wherein the plurality of elements are provided in an array on a sheet.

10. An element of a decorative aggregate comprising a container, the container having a bottom wall and side walls delimiting a cavity, said bottom wall and side walls being made of a textile material or felt, and wherein at least the bottom wall on its exterior side comprises a fastener, and the cavity is filled with a preserved vegetative material.
